(19) United States
(12) Patent Application Publication
(10) Pub. No.: US 2008/0319681 A1
(43) Pub. Date: Dec. 25, 2008

(54) Method of extracting qualitative and quantitative information from mixtures

(75) Inventor: Foo-tim Chau, Hong Kong (HK)

Correspondence Address: Foo-Tim Chau, The Hong Kong Polytechnic University, Hunghom, Kowloon, HK

(73) Assignee: The Hong Kong Polytechnic University, Hong Kong (HK)

(21) Appl. No.: 11/819,003

(22) Filed: Jun. 25, 2007

(51) Int. Cl. G06F 19/00

(52) U.S. Cl. 702/23

(57) ABSTRACT

The present invention relates to methods for extracting qualitative and quantitative information from natural ingredient mixtures, utilizing two or more data sets and newly developed chemometric method known as improved alternative moving window factor analysis (IAMWFA).

### BACKGROUND

Qualitative and quantitative analysis of multi-components in complex mixtures, like herbal medicines, are a challenge to analytical chemists. Many conventional methods attempted to attain these goals with the help of experimental extraction and separation. But these methods require a lot of time, labor and money to obtain these goals, with no guarantee of success. In the last decades, rapid development of chromatographic instruments, especially hyphenated instruments like GC-MS, GC-TOF-MS, HPLC-DAD, LC-MS, CE-DAD, and others, provide rich chromatographic and spectral information of chemical components of mixtures. They have been the preferred tools in the investigation of complex systems. Even with the high dimensional chromatographic data of mixture samples of very complicated profiles at hand, it is still difficult for chemists to get the most qualitative and quantitative information of pure chemical components. Samples of herbal medicines, metabonomics, and system biology with hundreds, even thousands of chemical components are examples of common complex systems of this kind.

Powerful chemometric data processing techniques coupled with powerful PC have been developed in the last decades to extend the use of chromatographic data from advanced analytical instruments. This led to improve significantly the efficiency in information extraction from these information rich data. At present, most existing chemometric methods, including Heuristic evolving latent projection (HELP), are limited by extracting the chemical component information from one data set obtained from the sample studied. Thus, these methods cannot be used in the resolution of one or more minor components completely embedded by a large chromatographic profile (known as embedded overlap components) of a sample mixture. Also, comparison of multi-components among different mixtures is very difficult and time-consuming. The recently reported methods, including component resolution method (CRM), spectral correlative chromatography (SCC) and multi-component spectral correlative chromatography (MSCC) are very helpful to get information of chemical components present and/or absent between different mixtures through comparing the different but related data sets from one more mixture similar to the one studied. Another similar sample can provide more information to increase the chance to discover more of their chemical constitutes. With herbal medicine as an example here, similar sample means the mixture acquired under different experimental conditions, types of instruments, chromatographic columns, curative parts of the same herbs, collection seasons, storage conditions, and others. However, most chemometric methods cannot be employed to extract the chromatographic and spectral profiles of pure target components in a simple and time-saving way. In many cases, this type of information is also important to scientists.

It is one object of the present system to overcome the disadvantages and problems in the prior art.

### DESCRIPTION

The present invention proposes a method of qualitatively and quantitatively analyzing complex mixtures utilizing a new chemometric method.

The present invention also proposes a method of using a new chemometric method, such method that utilizes at least two sets of data to obtain more chemical information about pure common components evident in the mixtures used to generate the data sets.

The present invention further proposes a method capable of providing more indepth study and characterization of natural ingredients mixtures, such as herbal medicines, through the use of newly developed chemometric methods.

These and other features, aspects, and advantages of the methods of the present invention will become better understood from the following description, appended claims, and accompanying drawings where:

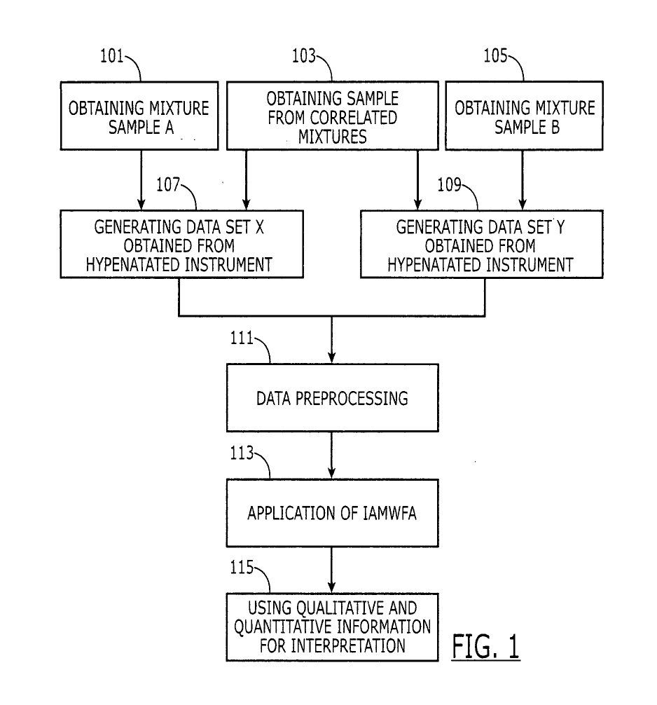

FIG. 1 exhibits a method of extracting information from complex mixtures in accordance with the present invention;

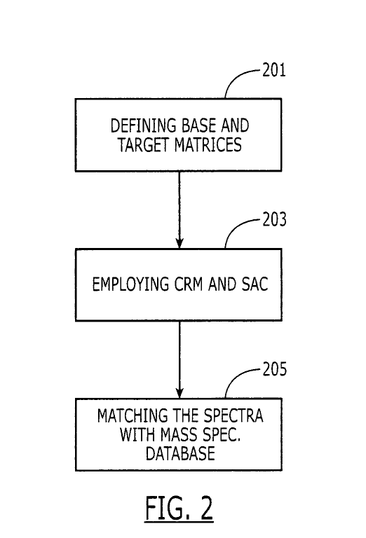

FIG. 2 is an embodiment of the chemometric method, IAMWFA, employed in the method of FIG. 1;

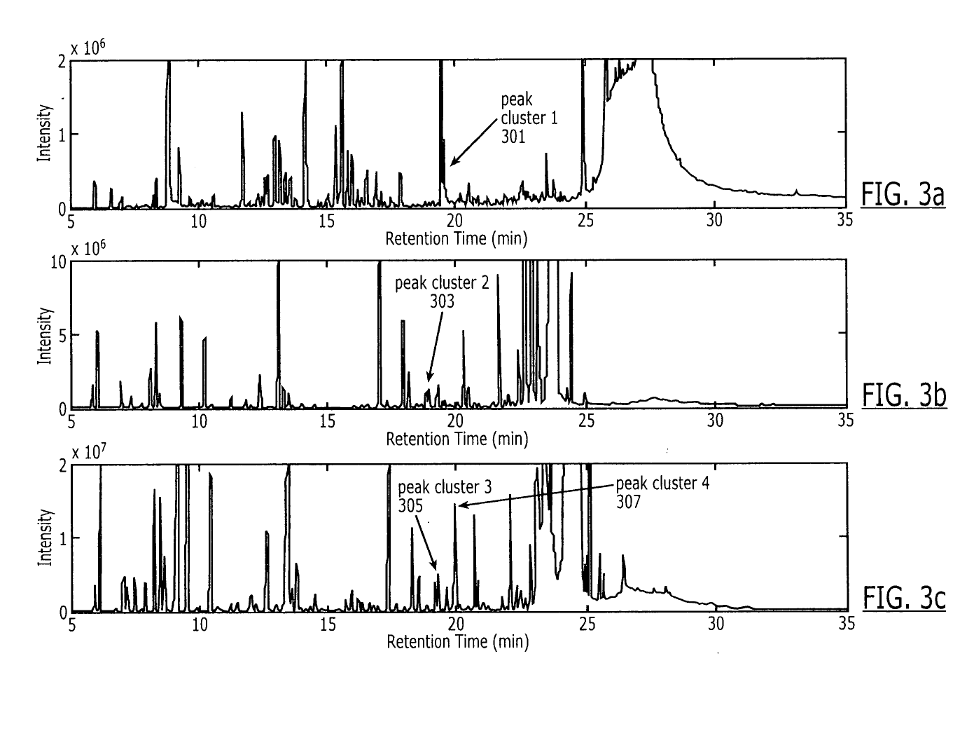

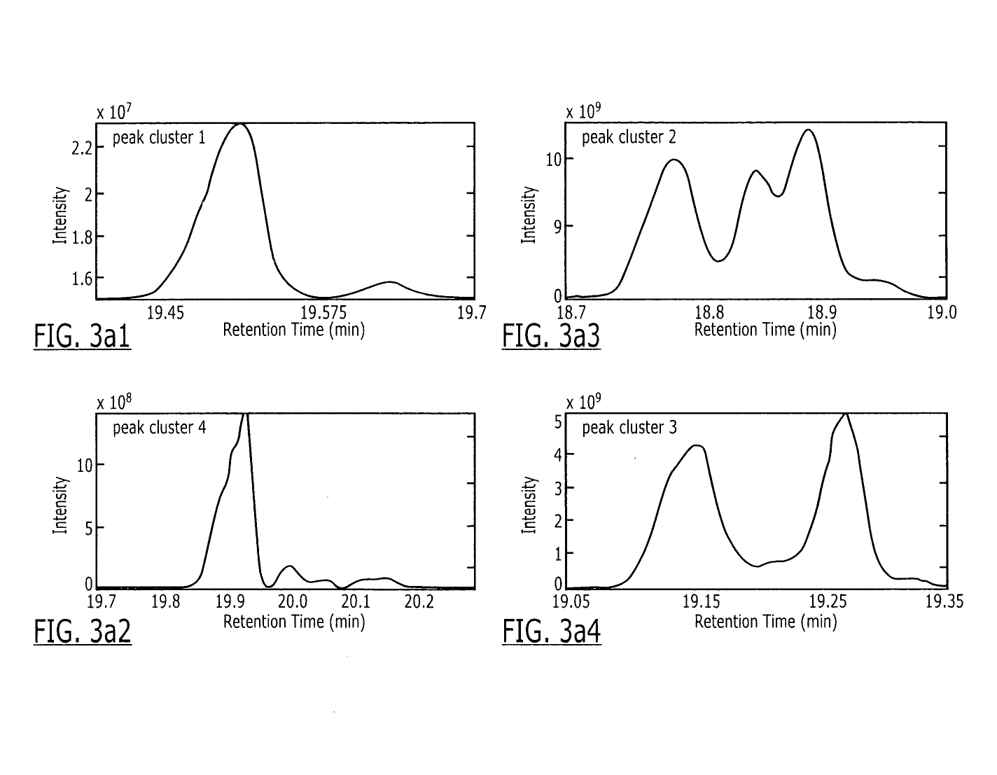

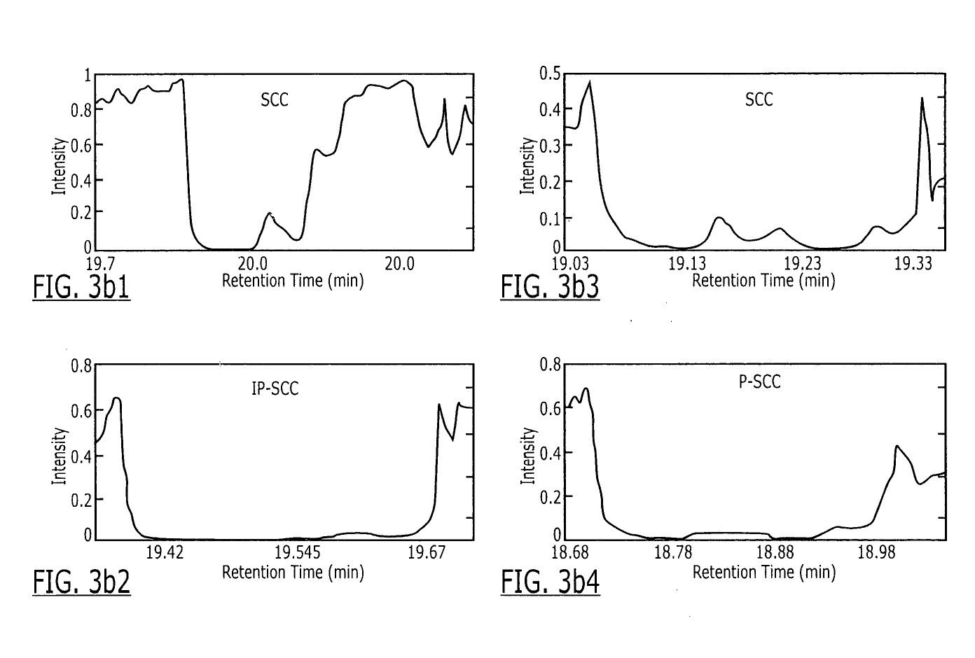

FIG. 3 sets forth, in reference to the Example, shows the totalion current chromatogram of two mixtures and one overall mixtures;

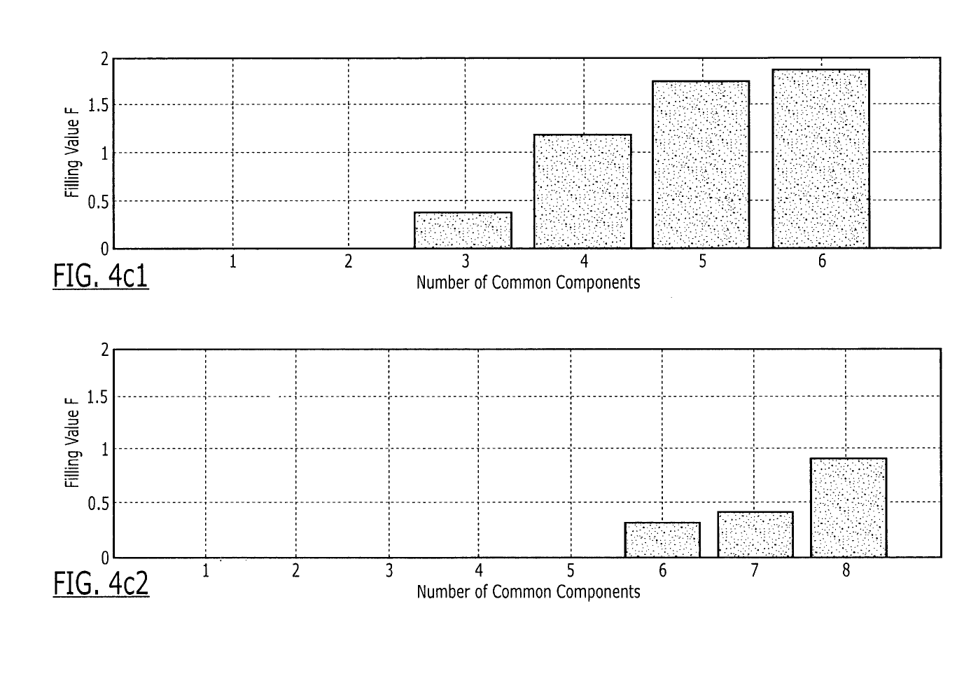

FIG. 4 shows the further processed spectra; and

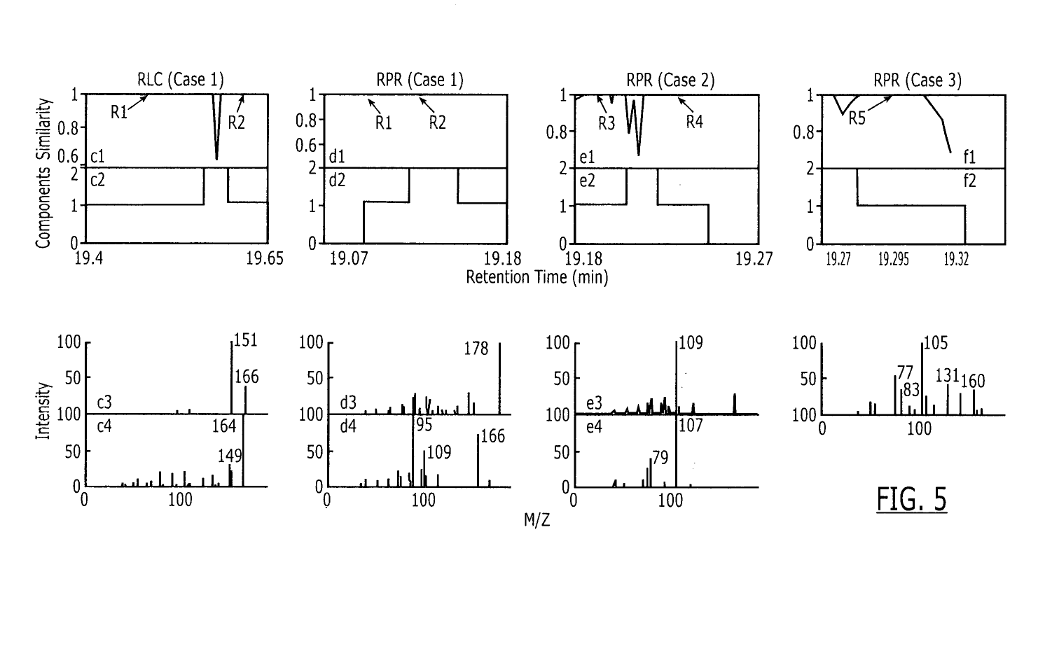

FIG. 5 shows the result of applying SAC to the processed spectra.

The following description of certain exemplary embodiment(s) is merely exemplary in nature and is in no way intended to limit the present invention, its application, or uses. Throughout this description, the term “natural ingredient” shall refer to those substances found in nature which comprise whole plants and herbs, anatomical parts thereof, vegetable saps, extracts, secretions, and other constituents thereof, glands or other animal organs, extracts, secretions and other constituents thereof, and which have not had changes in their molecular structure as found in nature. “Natural ingredient” may also mean any product which has been advanced in value or improved in condition from its crude state by any mechanical or physical process whatever beyond that which is essential to its proper packing and the prevention of decay or deterioration pending manufacture, but does not include any product which has been artificially mixed with other substances or the molecular structure of which as found in nature has been changed.
Now, to FIGS. 1-5,

FIG. 1 is a method of extracting qualitative and quantitative information from natural ingredient mixtures in accordance with the present invention, including the steps of obtaining at least two mixture samples (101/105), one overall mixture of the various mixtures (103), generating spectra data sets (107/109), preprocessing such data (111), applying the chemometric tool of the present invention (113), and using the generated qualitative and quantitative information to interpret the characteristics of the mixtures (115).

Obtaining the mixtures samples (101/105) can comprise removing a sample from the mixture, such sample being of sufficient amount to allow analysis by instrument. Each mixture may be comprised of one or more natural ingredients contained within an aqueous medium, for example distilled water, deionized water, and the like. The mixture can be, for example, an herbal medicine, such as a traditional Chinese medicine, capable of providing a physiological effect to the person administered the mixture. Methods of obtaining a sample from the mixture (101/105) include well-known methods in the art, such as extraction, separation, distillation, pipeting, suction, and the like. In one embodiment, and as will be discussed later, the sample is obtained directly by a chromatographic instrument that will perform a spectra-analysis on the sample.

Regarding the amount of sample obtained, it should sufficient to allow spectra-analysis thereon. In usual circumstances, this amount is from several micromilliliters to several milliliters.

A sample from an overall mixture of the various mixtures is then obtained (103). The overall mixture can be made by various methods, including mixing the natural ingredients used to make the various mixtures (101/105) together in one aqueous solution, extracting from the various mixtures (101/105) volume amounts and then combining them to form the overall mixture (103), or using different parts of the natural ingredient as used to make the various mixtures (101/105) and combining these different parts to form the overall mixture (103). As an example of using different parts to form the overall mixture (103), the leaves of the natural ingredients may be used to make the mixtures (101/105), but the stems of the natural ingredients may be used to make the overall mixture (103).

Data sets X(107) and Y(109) are then generated by a hyphenated instrument. In generating the data sets (107/109), the obtained samples are injected or exposed to the hyphenated instrument. Exposure can include placing the samples within the instrument, allowing the instrument to suction the sample, and the like. Hyphenated instruments suitable for analyzing the samples include Gas Chromatography-Mass Spectrometry (GC-MS), High Performance Liquid Chromatography-Diode Array Detector (HPLC-DAD), HPLC-MS, Capillary Elechrophoresis-DAD (CE-DAD), Liquid Chromatography-MS (LC-MS), etc. As is well-known in the art, the hyphenated instruments provide chromatographic and spectral information of the chemical components in the mixtures. The data sets X(107) and Y(109) can be generated individually by supposing the system generates a data set with rows and columns corresponding to spectra (Sₙ) measured at different times and chromatograms acquired at a different wavelength

$$X = {\sum }_{n = 1}^{N} {C}_{n} {S}_{n}^{+} + E = {CS}^{+} + E$$

where N and E represent the total number of components and noise in the sample.

The generated matrix shows the extracted chemical information as an input parameter

$$X = [ \begin{matrix}{X}_{1 , 1} & {X}_{1 , 2} … & {X}_{1 , i - 1} & {X}_{1 , i} \\ {X}_{2 , 1} & {X}_{2 , 2} … & {X}_{2 , i - 1} & {X}_{2 , i} \\ {X}_{j - 1 , 1} & {X}_{j - 1 , 2} … & {X}_{j - 1 , i - 1} & {X}_{j - 1 , i} \\ {X}_{j , 1} & {X}_{j , 2} … & {X}_{j , i - 1} & {X}_{j , i}\end{matrix} ]$$

where i=number of markers, number of constituents & number of canned data points in the whole chromatographic profile in number of j analyzed samples, under marker approach, multi-component approach & pattern approach.

The manufacture of such data sets is performed as taught in Chan Chi-On, “Applications of Chemometrics Techniques on Chromatographic and Spectroscopic Methods to Advance Chemical Analysis of Radix Liqustici Chuanxiong, Radix Angelicae Sinenis, Cortex Phellopendri, and other Chinese herbal medicines” (2006) (unpublished Ph.D. thesis, The Hong Kong Polytechnic University), incorporated herein by reference.

Preprocessing of the data sets are then performed (111), for example by normalizaton, to avoid variation in the sample concentration, and local least square to eliminate the effect of chromatography shift on data analysis.

The step of improved alternative moving window factor analysis (IAMWFA) is then performed on the data sets (113). The IAMWFA method can get more chemical information of pure common components buried in chemical chromatographic peaks of different systems. In comparison to other methods of chemometric data processing, IAMWFA combines the similarity computation of a series of candidate spectra obtained from other techniques with the elution chromatographic windows to mine the spectra of target components. This improves the veracity and efficiency in the process of getting the final spectra of interested components. Further, it will save much time and labor in the investigation of systems with large number of chromatographic peaks. Combination of the available chromatographic profiles of the pure target components from conventional curve fitting techniques with the results of spectra from IAMWFA, the complex systems can be significantly simplified via the bi-linear decomposition method. That is to say, the residual matrix will be easily processed with IAMWFA after getting the information of chromatographic and spectral profiles of the pure target components at hand. This will significantly improve the potential ability of the component resolution of IAMWFA method. In IAMWFA method, the resolution of complicated mixtures with embedded overlap components can be achieved through alternative employment of selective information of components in different but related mixture samples.

The qualitative and quantitative information generated from IAMWFA is then utilized for interpreting the components of the mixtures, and correspondingly the natural ingredients (115). Interpretation can be performed by comparing the spectral data against known databases, for example NIST Database (NIST 147) mass spectral database, or Wiley 138 Library. The interpretation should offer a means of determining the similarity of the components against known components. Similarity can be computed by the dot product of the two mass spectra of pure components obtained from IAMWFA and from the matched components found in the database. In one embodiment, similarity can be shown by

$$r ( i , j ) = \frac{( {S}_{i} - \overline{{S}_{i}} ) T \cdot ( {S}_{j} - \overline{{S}_{j}} )}{norm \vert ( {S}_{i} - \overline{{S}_{i}} ) \vert \cdot norm \vert ( {S}_{j} - \overline{{S}_{j}} ) \vert}$$

created from x and y being graphic data sets of two different samples and sᵢ, sⱼ are spectra of ith and jth component of x and y, where sⱼ=mean of spectral vector sᵢ. The higher the r(i,j) value, the higher the correlation between the two components. r=1 means the two spectra are identical. To be similar, the r value of the present invention can be between 0.85 and 1.

FIG. 2 is an embodiment of the IAMWFA method utilized in the present invention. As indicated previously, the IAMWFA method is utilized to provide chemometric techniques to spectra derived from natural ingredient mixtures. The IAMWFA method includes defining the base and target matrices 201 of the data sets created from the spectra, employing common rank map (CRM) and spectral auto-correlative curve (SAC) to the base and target matrices 203, and then matching the spectra to a database 205.

Defining the base and target matrices 201 from the data sets X and Y, as indicated in FIG. 1, occurs with the assistance of fixed size moving window evolving factor analysis (FSMWEFA). In general, FSMWEFA is used to find peak purity in the spectra. Firstly, a noise level is characterized by eigenvalve curves. Eigenvalues that curve higher than the noise level represent the existence of new components in the mixture. Secondly, the number of rows of X greater than 1 is selected, and their eigenvalues are computed. The window is then moved down until the last row on X is manipulated. At the ends, all the first eigenvalues are connected with a line and procedure is applied to other eigenvalues.

Common Rank Map (CRM) and Spectral Auto-correlative Curve (SAC) are then employed 203 or applied to the defined base and target matrices 201. The CRM and SAC, based on alternative window search, are employed to obtain the number of common components and the spectra of pure components in data sets X and Y. CRM is used to give more reliable and accurate information on the components present. With the use of locating the zero-component regions and local rank analysis, the information available is sufficient for correcting the background and drifting, accurately.

Under the theory of SAC, the same chemical component should have the same spectrum no matter how it is eluted through a column. SAC is accomplished by assessing peak purity of a targeted component and then acquiring its spectrum, either via UV or MS, for the chromatogram. The component is then identified in other chromatogram(s) of interest through comparing by a series of the spectrum via their correlation coefficient. The correlation coefficient is compared against the scan point in the direction of retention time.

As discussed previously, the resulting spectra is then compared against existing database (205), such as, NIST Mass Spec database or Wiley 138 database.

Compared to other methods, the IAMWFA method combines the similarity computation of a series of candidate spectra obtained from CRM and SAC techniques with the elution chromatographic windows to mine spectra of pure target components. Also, the selectively of components obtained from factor analysis is used to extract the target and base matrices in IAMWFA method. Furthermore, an additional reference index with the information of known noise level of data sets is set up to assess the common and non-common components in the needle search step, which is crucial in IAMWFA analysis. Especially, if the chromatographic profiles of the target components can be extracted with the conventional curve fitting techniques, the complex systems can be significantly simplified via the bi-linear decomposition method and pure spectra available through IAMWFA. That is to say, the residual matrix will be easily processed with IAMWFA after getting the information of chromatographic and spectral profiles of the pure target components at hand. This method can also find out one or more minor components that are completely embedded within a large chromatographic profile (known as embedded overlap component peak). Of course, IAMWFA will be more powerful with the use of the existing chemometric methods to obtain the integrated relationship of chemical components first. IAMWFA can help to discover the qualitative and quantitative information of hidden constitutes with no pure spectra even found in the complex mixtures. Hence IAMWFA can identify and quantify the very complicated multi-component in complicated mixtures of certain herbal medicines with their chromatographic peaks embedded together. The main advantage and strategy of IAMWFA method is the integrated consideration of selective information of chemical components hiding in two different but correlated hyphenated chromatographic data sets X and Y, while only one set is employed by methods in the prior art. That is to say, the selective information of components in X can help to resolve the same components in Y, or vice versa. Moreover, the users can further verify the resolution results to different extracts by using IAMWFA itself. The pure component information extracted from the complex mixtures can further be validated through changing the extraction of base and target matrices in this method. IAMWFA is very effective in discovering the relationship of common chemical components between different samples of very high complexity like herbal medicines. Additionally, the analytical procedures of this method are semi-automatic such that it does not require the users to have a strong chemometrics background to manipulate results and take further action in each step. For instance, the qualitative and quantitative information of the active constitutes in herbal medicines simultaneously exist in different curative parts of herbs, different collection seasons, storage conditions, and others. Utilization of two related data sets instead of one is definitely superior to the use of one data set in conventional approach. Most conventional resolution methods focused on the analysis of only one sample of the target herbal medicine under one experimental condition. Therefore, it handle poorly the complex chromatographic peak clusters with too many overlap clusters from chemical components. New IAMWFA can exists an an algorithm encoded by well-known programming languages, for example Matlab™, C, C++, and the like. Such encoded algorithms can be store on a computer system, for example a desktop, laptop, or handheld model. The computer system can comprise a microprocessor, user interface devices for example a keyboard, storage means such as RAM or ROM whereby the algorithms may be stored, display means such as a monitor, and output means such as a printer.

### EXAMPLE

The volatile chemical components of two single herbal medicines, rhizoma ligustici chuanxiong (RLC) and radix paeoniae rubra (RPR) and their mixture RLC-RPR were determined with the method of the present invention.

FIG. 3 shows the total ion current chromatograms of the two mixtures and the overall mixture (RLC is 3(a); RPR is 3(b); and PLC-RPR is 3(c)). In each chromatogram, peaks (301, 303, 305, 307) were further processed, and exhibited in FIG. 4(a1-a4) to show the detailed structures of the chemical components present. It is obvious that conclusions cannot be easily drawn on the presence and absence of chemical components by using the single herbal medicine RLC, RPR, or RLC-RPR alone. In our IAMWFA methodology, the integrated relationships of the chemical components in FIG. 4(a1-a4) are obtained by MSCC and IP-MSC. 4(d) and 4(c2) show the number of common components between the natural ingredients.

CRM and SAC were then utilized to get the spectra of pure components from data sets X and Y. FIG. 5(c1, d1, and f1) show the results from CRM. FIG. 5(c2, d2, e2, and f2) show the results from SAC. The spectra of the target components obtained from these two mixtures and the overall mixture matched with those from the NIST mass spectral database for comparison purposes, as shown in FIG. 5(c3 and c4, d3 and d4, e3 and e4, f3 and f4). The similarity between the chemical components and the NIST database was calculated and is shown in Table 1.

TABLE 1

| | | Information of the identified components | | |
|---|---|---|---|---|
| | | Molecular | | |
| No. | Similarity | formula | Molecular name | Structure |
| 1 | 0.9887 | C₉H₁₀O₃ | 2′,4′-dihydroxy-3′-methylace-tophenone | 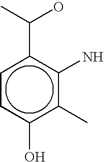 |
| 2 | 0.9567 | C₁₀H₁₂O₂ | 2-methoxy-6-[1-propenyl]-phenol | 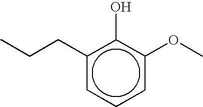 |
| 1 | 0.9810 | C₁₁H₁₄O₂ | 1,2-dimethoxyl-4-[2-propenyl]-benzene | 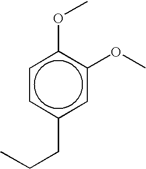 |
| 2 | 0.8640 | C₁₁H₁₈O | tricyclo[4.3.1.13,8]undecan-3-ol | 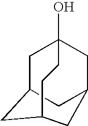 |
| 3 | 0.9861 | C₁₁H₁₄O | 2-methyl-1-phenylbut-en-1-ol | 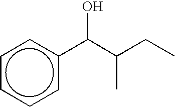 |
| 4 | 0.9369 | C₁₀H₁₄O₂ | 3a,4,5,7a-tetrahydro-4-hydroxy-3a,7a-dimethyl-,[3a.alpha.,4.beta.,7a.alpha.]-1[3H]-isobenzofuranone | 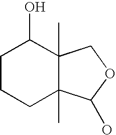 |
| 5 | 0.9119 | C₁₁H₁₂O | 2-buten-l-one,2-methyl-l-phenyl | 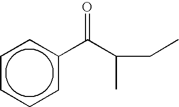 |

Having described embodiments of the present system with reference to the accompanying drawings, it is to be understood that the present system is not limited to the precise embodiments, and that various changes and modifications may be effected therein by one having ordinary skill in the art without departing from the scope or spirit as defined in the appended claims.

In interpreting the appended claims, it should be understood that:

a) the word “comprising” does not exclude the presence of other elements or acts than those listed in the given claim;

b) the word “a” or “an” preceding an element does not exclude the presence of a plurality of such elements;

c) any reference signs in the claims do not limit their scope;

d) any of the disclosed devices or portions thereof may be combined together or separated into further portions unless specifically stated otherwise; and

e) no specific sequence of acts or steps is intended to be required unless specifically indicated.

1. A method of extracting qualitative and quantitative information from a natural ingredient mixtures, comprising the steps of:
obtaining mixture samples;
obtaining an overall mixture sample;
generating data sets for said mixture samples and said overall mixture sample;
preprocessing said data sets;
applying IAMWFA chemometric method; and
using qualitative and quantitative information from said IAMWFA chemometric method for interpreting said mixture samples.

2. The method of claim 1, wherein said mixture samples are natural ingredient mixtures.

3. The method of claim 1, further comprising the step, prior to obtaining said overall mixture sample, of making said overall mixture by a method from the group consisting of mixing the natural ingredients used to make the various mixtures together in one aqueous solution, extracting from the mixture samples volume amounts and then combining then to form the overall mixture, and using different parts of the natural ingredient as used to make the various mixtures and combining these different parts to form the overall mixture.

4. The method of claim 1, wherein said data sets are generated by a hyphenated chromatographic instrument.

5. The method of claim 1, wherein said IAMWFA chemometric method comprises the steps of:
defining base and target matrices;
employing Common Rank Map (CRM) and Spectral Auto-Correlative Curve (SAC) to said matrices; and
matching the result spectra with a mass spectral database.

6. The method of claim 5, wherein defining said base and target matrices comprises the step of utilizing fixed size moving window evolving factor analysis (FSMWEFA).

7. The method of claim 5, wherein said IAMWFA chemometric method exists as an encoded algorithm.

8. The method of claim 1, wherein there are two of said data sets.
